(19) United States
(12) Patent Application Publication
(10) Pub. No.: US 2013/0116354 A1
(43) Pub. Date: May 9, 2013

(54) HIGH PERFORMANCE FOAM AND COMPOSITE FOAM STRUCTURES AND PROCESSES FOR MAKING SAME

(71) Applicants: Aashish Rohatgi, Richland, WA (US); Raymond S. Addleman, Benton City, WA (US); Bradley J. Busche, Shelby, NC (US)

(72) Inventors: Aashish Rohatgi, Richland, WA (US); Raymond S. Addleman, Benton City, WA (US); Bradley J. Busche, Shelby, NC (US)

(73) Assignee: BATTELLE MEMORIAL INSTITUTE, Richland, WA (US)

(21) Appl. No.: 13/290,890

(22) Filed: Nov. 7, 2011

(51) Int. Cl. B29C 44/18; B05D 7/24; C08G 63/685; C08J 9/00; C08J 9/08; C08J 9/14; C08J 9/10; B29C 44/34; C08G 63/06

(52) U.S. Cl. 521/97; 264/50; 264/46.6; 427/238; 521/180; 521/182; 521/98; 521/82

(57) ABSTRACT

Methods are disclosed for making liquid crystalline polymer (LCP) foams and foam structures of various shapes and forms. LCP foams of the invention have a high compression strength suitable for high performance energy-absorption and energy-impact applications and devices.

### STATEMENT REGARDING RIGHTS TO INVENTION MADE UNDER FEDERALLY-SPONSORED RESEARCH AND DEVELOPMENT

This invention was made with Government support under Contract DE-AC05-76RLO-1830 awarded by the U.S. Department of Energy. The Government has certain rights in the invention.

### FIELD OF THE INVENTION

The present invention relates generally to polymer foams and foam-containing structures and methods of making. More particularly, the invention relates to high performance liquid crystalline polymer (LCP) foams and composite foam structures and processes for making same.

### BACKGROUND OF THE INVENTION

Current needs exist for light-weight, high-strength materials that can be easily processed and mass produced in an industrial setting for use in structural components (e.g., within motor vehicles). Polyurethane (PU) or polystyrene (PS) foams are common foams that are relatively soft and have a low compressive strength. Such foams are ell-suited for light-weight and low-energy absorption applications, but are not suitable for applications that require high stiffness, high strength, and high energy absorption properties. While some metal foams (e.g., aluminum foams) are light-weight and possess a greater mechanical strength than do PU or PS foams, they are difficult to make due to their processing conditions. For example, aluminum foams require processing temperatures greater than 660° C. and further are typically manufactured in a planar sheet geometry. The elevated temperatures required for processing and the difficulty associated with integrating planar structures into complex and contoured parts e.g., hollow tubes, remains a problem. Further, the high temperatures used to process metal foams can after the mechanical integrity of integrated structures, e.g., while the metal foam is in contact with sister parts. Other processing challenges exist with metal foams including, e.g., release of hazardous gases. In one approach, aluminum powder is mixed with TiH₂ powder. The mixture is then heated near the melting temperature of aluminum to decompose the TiH₂, which forms the aluminum foam but also releases H₂ gas—a chemical hazard. Another problem with metal foams is that the compressive strength and modulus scale as a function of the foam density. This means that low density metal foams typically exhibit a low compressive strength and modulus, and vice-versa.

Therefore, an improved process is needed that provides foams and composite foam structures that exhibit a high compressive strength, a high modulus, and a high-energy absorption capacity, suitable weight properties (e.g., for weight-limited applications), and volumetric footprints (e.g., for space-limited applications) that do not generate dangerous gases (e.g., hydrogen gas), and ultimately can minimize need for hazardous metals.

The present invention meets these needs. Additional advantages and novel features of the present invention will be set forth as follows and will be readily apparent from the descriptions and demonstrations set forth herein. Accordingly, the following descriptions of the present invention should be seen as illustrative and not as limiting in any way.

### SUMMARY OF THE INVENTION

The present invention includes liquid crystal polymer (LCP) foams and processes that produce same. In various embodiments, liquid crystal polymer (LCP) foams of the present invention include neat and composite LCP foams, and neat and composite LCP foam structures having a high specific strength, a high specific modulus, and a high specific absorption energy. In some embodiments, the process includes infusing a quantity of liquid crystalline polymer with a pressurized fluid at a selected fluid pressure and a selected temperature, and expanding the infused liquid crystalline polymer to form a solidified liquid crystalline polymer foam or polymer foam structure.

In various embodiments, pressurized fluids for infusing and/or expanding the LCP to form LCP foams, composite foams, and foam structures include, but are not limited to, e.g., CO₂, Ar, Xe, N₂, Kr, CH₄, C₂H₆, C₃H₈, including combinations of these pressurized fluids.

In some embodiments, the pressurized fluid is a liquid, a near-critical fluid, or a supercritical fluid.

In some embodiments, the pressurized fluid includes a pressure from about 1,000 psi to about 10,000 psi.

In some embodiments, LCP foams and LCP foam structures of the invention are prepared by infusing solid LCP with a fluidized gas under pressure and then rapidly (e.g., milliseconds) reducing the pressure and/or temperature to form the LCP foam or composite foam structure. However, other times for reduction of pressures and temperatures can be employed without limitation.

In some embodiments, the liquid crystalline polymer is infused as a solid or in a semi-solid state.

In various embodiments, the LCP solid may be of a form including, but not limited to, e.g., chunks, pellets, flakes, granules, particles, beads, including combinations of these various solid forms.

In some embodiments, the liquid crystalline polymer is infused in a molten or a fused form.

In some embodiments, the liquid crystalline polymer is infused at a temperature above the melting point temperature of the liquid crystalline polymer.

In some embodiments, neat and composite LCP is infused with fluidized gas as a solid, a semi-solid, or a fused melt and expanded by rapid release of pressure and temperature yielding a LCP foam or a LCP foam structure.

In some embodiments, expansion of the LCP includes depressurizing the LCP.

In some embodiments, the process includes depressurizing a LCP that is previously infused with a pressurized fluid at a selected fluid pressure and temperature to expand the LCP, forming a solidified LCP foam or a LCP foam structure.

In some embodiments, the expansion temperature for foaming of the LCP is a temperature of at least about 280° C. In some embodiments, the expansion temperature for foaming of the LCP is a temperature greater than or equal to about 320° C. In some embodiments, the expansion temperature for foaming of the LCP is a temperature between about 300° C. and about 500° C.

In some embodiments, the process includes introducing a quantity of LCP polymer in a solid pelletized form into a container of defined shape. Atmospheric gases are then purged from the container with an inert gas. The container is then pressurized under anaerobic conditions with a fluidized gas at a liquid, near-critical, or supercritical pressure to infuse the LCP polymer with the fluidized gas. Then, the infused LCP polymer is heated to at least the melting point of the LCP polymer for a time sufficient to fuse the LCP polymer into a single LCP polymer mass. Next, pressure and/or temperature of the fused LCP polymer is reduced at a selected rate, which expands the LCP polymer and forms a solidified foam.

In some embodiments, the solidified liquid crystalline polymer foam at least partially fills the container. In some embodiments, the solidified liquid crystalline polymer foam completely fills the container.

In some embodiments, expansion of the LCP foam performed in-situ in a container having a selected shape yielding a LCP foam or a LCP foam structure with a selected shape.

In some embodiments, the container is a component of the LCP polymer foam or polymer foam structure.

In some embodiments, a container is embedded within the LCP polymer foam or LCP polymer foam structure.

In some embodiments, expansion of the LCP foam includes cooling the liquid crystalline polymer foam to solidify the loam.

In some embodiments, the process includes thermally aging the solidified liquid crystalline polymer foam to maximize at least one mechanical property of the solidified foam.

In some embodiments, the process includes shaping the solidified liquid crystalline polymer foam to form a composite foam or composite foam structure.

In some embodiments, the LCP foam is a neat LCP foam or neat LCP foam structure. In some embodiments, the LCP foam is a composite foam or a composite foam structure. In some embodiments, the LCP foam is a component of the foam or composite foam structure and includes a defined shape. In some embodiments, the LCP composite foam or composite foam structure includes a reinforcing phase (i.e., reinforcing constituents) that adds to the mechanical strength of the resulting foam. In various embodiments, reinforcing constituents present in LCP composite foams and composite foam structures of the present invention may include fibers, particles, spheres, flakes, and other added components of various shapes and sizes, as well as other reinforcing constituents composed of materials including, but not limited to, e.g., glass, carbon, ceramics, metals, including combinations of these various reinforcing constituents. Reinforcing constituents can be mixed with the neat polymer at quantities from about 0 wt % to about 50 wt %, or greater depending on the desired mechanical properties (e.g., strength, modulus, energy absorption, compression, etc.) of the resultant foams and composite foams. In some embodiments, LCP containing a reinforcing phase or other added fillers and constituents above about 50 wt % may require greater processing temperatures to lower the viscosity of the polymer prior to expansion in order to properly expand the polymer that results in the desired foam. Upper limit for added constituents for composite foams and composite foam structures depends in part upon factors including, but not limited to, e.g., viscosity and melt-strength. Melt strength is a property of the polymer melt which assesses the ability of the melt to withstand drawing without breaking.

In some embodiments, LCP foams and foam structures of the present invention have a high compression or high specific strength. The term “specific strength” for LCP foams described herein is defined as the compressive mechanical strength of the foam (i.e., under compression) divided by its density. The term “specific modulus” as used herein to describe LCP foams of the invention (a measure of stiffness) is defined as the Young's modulus measured under compression divided by the foam density. The term “specific energy absorption” densification is defined as the energy absorbed up to the densification strain divided by the foam density. For LCP polymer foams and composite foams detailed herein, a specific compression strength greater than 10 MPa·cc/g, a specific compression modulus greater than 100 MPa·cc/g, and a specific energy absorption greater than 5 J/g are considered to be “high” values for each of these properties, respectively. The term “composite” as used herein means the LCP foam or LCP foam structures contain added constituents, components, or parts in addition to the foam.

In some embodiments, the composite foam structure is a layered structure.

In some embodiments, composite foams of the invention are prepared as structured or sandwich composites, in which (neat or composite) foams of the invention are placed, e.g., between sheets or panels composed of selected structural or other materials including, e.g., fiberglass, glass, or metal. In some embodiments, sandwich composites are composed of neat polymer foams. In some embodiments, sandwich composites include composite polymer foams, i.e., foams containing reinforcing constituents. In various embodiments, sandwich composites include light-weight composite foams or light-weight composite foam structures.

In some embodiments, a composite LCP polymer containing reinforcing constituents and/or fillers is infused with the fluidized gas and foamed by rapid release of pressure and temperature to yield a composite foam or composite foam structure. In various embodiments, composite foams and foam structures can include various mixtures of neat polymer, composite polymer, reinforcing constituents, and or other constituents. These mixtures are then infused with fluidized gas and foamed together to form the composite foam or composite foam structure. Composite foams of the invention containing reinforcing constituents show greater mechanical properties than foams made from the neat polymer alone without a reinforcing phase. In some embodiments, the process includes infusing a quantity of LCP with a fluidized gas at a liquid, near-critical, or supercritical fluid pressure at a temperature above the melting temperature of the LCP, and then rapidly reducing the pressure and temperature of the fluid infused LCP, which causes the LCP to expand and form a solidified LCP foam.

In various embodiments, the LCP includes one or more added materials prior to foaming of the foam including, but not limited to, e.g., glass, fibers, polymers, reinforcing components, including combinations of these various materials.

In some embodiments, the LCP foam includes substantially uniform cells with a cross-sectional diameter less than or equal to about 100 μm.

In various embodiments, the infused LCP is expanded into various structures including, but not limited to, e.g., tubes, honeycombs, hollow structures, other structures; parts including, e.g., molded parts; or structural components including, e.g., panels, yielding a LCP foam or composite foam structure. In some embodiments, LCP foam is a component of a liquid crystalline polymer foam structure or a composite foam structure.

In some embodiments, the LCP foam is a component of a hollow part. In some embodiments, the LCP foam is a component of a flexible fabric, In some embodiments, the LCP foam is a component of an impact structure. In some embodiments, the LCP foam is a component of a blast shield or a blast shield structure. In some embodiments, the LCP foam is a component of body armor. In some embodiments, the LCP foam is included in a structural panel or component of a vehicle. In some embodiments, the LCP foam is a component of an energy absorption device. In some embodiments, the LCP foam is a component of a sound modulation device. In some embodiments, the LCP foam is a component of a temperature modulation device. In various embodiments, the LCP foam is a composite LCP foam structure including one or more of the following: a honeycomb structure, a mesh, a fabric, a nanomaterial, a ceramic, a metal, a planar plate, and combinations of these various materials. Nanomaterials include, but are not limited to, e.g., carbon nanofibers, carbon nanoparticles, carbon nanotubes, graphene, metal nanofibers, metal nanoparticles, ceramic nanofibers, ceramic nanoparticles, polymer nanofibers, and polymer nanoparticles. In some embodiments, the composite LCP foam includes glass fibers. In some embodiments, the composite foam structure is formed with a mold having a selected shape. In various embodiments, the mold can include various form and shapes and can be constructed of various materials. Following formation of the LCP foam and LCP foam structures, the mold can be removed by various known physical, chemical, or thermal processes known in the art to yield the composite foam structure.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

A more complete appreciation of the invention will be readily obtained by reference to the following description of the accompanying drawings in which like numerals in different figures represent the same structures or elements.

FIG. 1 is a schematic showing the exemplary system and process for forming composite foamed structures in accordance with the invention.

FIG. 2 shows a process for forming composite foam structures, according to a preferred embodiment of the invention.

FIGS. 3a-3b show a representative thermal profile and depressurization and cooling profiles for preparation of LCP foam in accordance with one embodiment of the invention.

FIGS. 4a-4b compares volume and viscosity changes of common supercritical fluids as a function of pressure and temperature.

FIG. 5 compares compression data for foams made using argon and CO₂.

FIGS. 6a-6b show relative density of LCP foams as a function of supercritical fluid processing time, and stress-strain performance curves of these foams produced in accordance with the invention at varying processing times.

FIG. 7a shows effect of foaming pressure on relative foam density.

FIG. 7b shows stress-strain performance curves of various foams produced in accordance with the invention at varying processing pressures.

FIG. 8 plots specific strength of thermally aged foams produced in accordance with the invention.

FIG. 9a compares energy absorption (at densification) per unit mass versus compression strength for LCP foams (at 25% strain) of the invention with conventional metallic foams.

FIG. 9b compares compressive strength as a function of foam density of LCP foams produced in accordance with the invention.

FIGS. 10a-10e illustrate various composite foam structures that can be constructed in accordance with the invention.

FIG. 11 is a photo showing an exemplary LCP foam structure made in accordance with the invention.

### DETAILED DESCRIPTION OF THE INVENTION

The invention includes processes that produce light-weight liquid crystal polymer (LCP) foams including neat and composite foams, and foam structures. In various embodiments, composite foam structures can be tailored to include a high compressive strength, a high modulus, a high energy absorption, and/or other advantageous properties, including combinations of these various properties. LCP foams, composite foams, and foam or composite structures of the invention find use in applications including, but not limited to, e.g., structural supports and panels for transportation applications (e.g., automobiles, aircraft, and other vehicles), blast and ballistic protection devices and structures, sound and vibration damping (e.g. in automobiles and aerospace vehicles), thermal insulation (e.g., in engines and residential housing) and like applications. And, while the present invention is described herein with reference to preferred embodiments, it should be understood that the invention is not limited thereto, and various alternatives in form and detail may be made without departing from the scope of the invention. Thus, no limitations are intended.

### System for Forming LCP Foams and LCP Composite Foam Structures

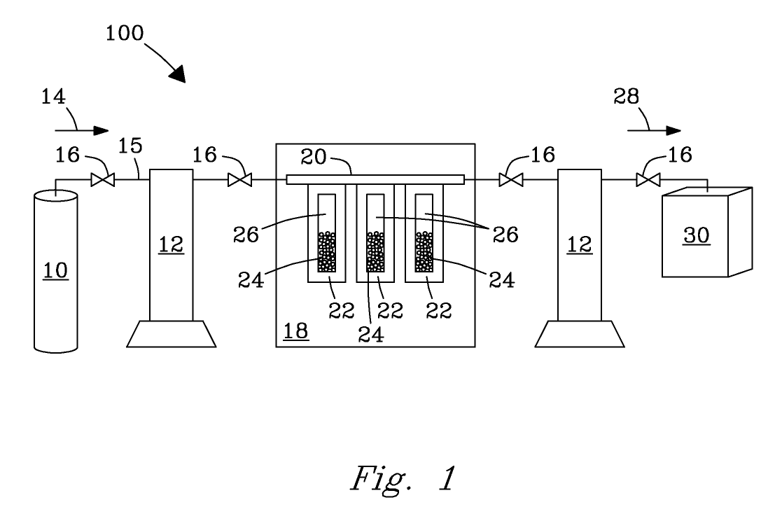

FIG. 1 shows an exemplary system 100 of a lab-scale design for forming LCP foams and composite foam structures. System 100 includes a high pressure foaming manifold 20 (constructed, e.g., of grade 316 stainless steel), having one or more high pressure containment vessels or enclosures 22 configured to house a container 26. The term “container” as used herein means any structure or enclosure with an internal fill volume. Exemplary containers include, but are not limited to, structures, enclosures, molds with complex or contoured shapes, parts, molded parts, hollow parts, structured parts, composite parts, panels, templated structures, patterned structures and objects, including combinations of these various structures and components, including those having preselected, complex, or otherwise contoured shapes. Foaming manifold 20 introduces a selected pressurized fluid into individual containers 26 containing a quantity of LCP 24 in a selected form (e.g., pellets, granules, flakes, particles, pre-form, etc.) placed into each container 26. The quantity of LCP introduced into a container is that quantity that when expanded as LCP foam is sufficient to fill the interior volume of the container partially or completely. In some embodiments, volume of the container is partially filled with LCP foam. In other embodiments, volume of the container is completely filled with LCP foam. No limitations are intended. One or more high pressure pumps 12 (e.g., ISCO D-series supercritical fluid syringe pumps) are coupled to deliver a pressurized fluid (e.g., Ar, CO₂) through foaming manifold 20 into containers 26 located within containment vessels 22 mounted within oven 18. Fluid cylinder 10 delivers the pressurized gas through a fluid inlet 14 located upstream from pumps 12 via high pressure valves 16 into high pressure pumps 12. Manifold 20 mounts into an oven 18 equipped with temperature control that provides direct thermal-control of temperature for containers 26 mounted therein. In the exemplary configuration, manifold 20 accommodates processing of one or more containers 26, each container 26 containing a quantity of LCP polymer 24 to be converted into LCP foam. Gases released from the foaming manifold 20 during or following depressurization of containers 26 are vented through other high pressure valves 16 located downstream from foaming manifold 20 to a fume hood 30, System 100 can be employed to infuse high pressure fluids into the containment vessels 22 and containers 26 introduced therein, that serves to fill containers 26 (e.g., molds, articles, parts) with LCP foam 32 yielding foam-filled articles, parts, as well as composite articles and parts. No limitations are intended, Containers, structures, and enclosures are not intended to be limited. Shapes for containers are also not limited. Containers provide a desired shape and fill volume into which the LCP foam or composite foam is expanded that yields a selected shaped or structured foam, or foam or composite foam structure. Foams of the invention also yield structures having desired or selected properties including, but not limited to, e.g., rigidity and strength. LCP polymer introduced into the container when expanded as LCP foam partially or completely fills the container, yielding a foam or composite foam structure, as described further herein.

While a lab-scale design has been described hereinabove, the invention is not intended to be limited thereto. For example, in various embodiments, the invention may be implemented at various industrial scales for use in industrial and other application environments and as will be understood by those of ordinary skill in the manufacturing arts. All systems and designs as will be envisioned or implemented in the art in view of the disclosure is within the scope of the invention. No limitations are intended.

### Diffusion of Fluidized Gas

Rate of diffusion of the fluidized gas into the LCP polymer is a function of the diffusion coefficient D, as given by Equation [1]:

D=D₀*exp^{-Ed/RT} [1]

Here, D₀ is the pre-exponential factor, E_{d} is the activation energy for diffusion, R is the gas constant (i.e., 8.3144×10⁻³ kJoules/Kelvin·mole), and T is the temperature in Kelvin. Time required for diffusion of the fluidized gas into the LCP polymer is inversely proportional to the diffusion coefficient D of the fluidized gas (e.g., ScF). Thus, raising the temperature increases the diffusion coefficient exponentially and proportionally reduces the time required for infusion or saturation. For example, the diffusion coefficient D of a SCF is generally greater when the polymer is molten than when the polymer is in the solid state. The diffusion coefficient D governing diffusion for a given fluidized gas into the polymer is influenced by parameters including, but not limited to, e.g., temperature and pressure, as well as chemical properties of the LCP and the fluidized gas. Other factors that influence D include the crystallinity of the polymer (an inverse relation); fillers and other added constituents typically reduce D; density of the polymer (an inverse relation); and potential for chemical interactions between the fluidized gas and the polymer. Factors that influence permeability and diffusion are detailed, e.g., by Pauly et al. in “Permeability and Diffusion Data” in Polymer Handbook, 3^{rd} Edition, eds. J. Brandrup and E. H. Immergut, John Wiley & Sons, 1989, pp. VI.434-VI.449, incorporated herein. All parameters as will be employed by those of ordinary skill in the art in view of this disclosure are within the scope of the invention. No limitations are intended.

In some embodiments, fluidized (pressurized) gas is infused into the LCP polymer at temperatures above the polymer melting point which softens or fuses the polymer, allowing the fluidized gas to rapidly diffuse into the polymer. In these embodiments, the LCP polymer then expands during depressurization at or above the same temperature to yield a desired polymer foam, foam structure, or composite foam structure. All temperatures and pressures as will be implemented by those of ordinary skill in the art in view of the disclosure are within the scope of the invention. No limitations are intended. For example, all temperatures and pressures that allow an LCP to absorb gas, flow, and expand into a foam can be used.

The term “melt temperature” as used herein means a temperature at which a solid LCP polymer (i.e., granules, pellets, etc.) begins to flow or absorb fluidized gas. Suitable polymer flow states for infusion include, but are not limited to, e.g., solid, semi-solid, semi-liquid, liquid, molten, fluid, or semi-fluid. In some embodiments, temperatures for infusion and foaming are performed above a manufacturer's stated melting point temperature (i.e., 280° C. for VECTRA B-130) such that the solid LCP flows, or such that the solid LCP has a suitable viscosity or the viscosity is sufficiently reduced to enable flow and infusion by the fluidized gas. The term “expansion temperature” means any temperature at which the fluid, semi-fluid, or otherwise molten LCP expands and foams as the absorbed fluidized gas expands. Conditions for effective expansion depend upon the selected LCP polymer, expansion fluid, and selected melt and expansion temperatures. Thus, processing conditions are not intended to be limited. For example, crystallinity and density of a polymer are strongly correlated. In general, the greater the crystallinity, the greater the density of the selected polymer. And, as the degree of crystallinity increases, the permeability decreases. LCP (e.g., VECTRA) can have highly ordered crystalline domains (a molecular alignment>80%), which can hinder diffusion of a pressurized gas or supercritical fluid into the LCP. Consequently, in some embodiments, infusion of the polymer with the pressurized fluid (e.g., supercritical fluid) is performed after the solid LCP melts because the molten polymer may erase crystalline and/or ordered domains of the solid LCP, which presents a lower diffusion barrier for saturation of the polymer by diffusion of the supercritical fluid than of diffusion occurs in either the solid state or the liquid crystalline state.

### Fluids for Infusion, Expansion, and Formation of LCP Foams

Liquid, near-critical, and supercritical fluids used to expand and form LCP foams of the invention include, but are not limited to, e.g., carbon dioxide (CO₂), nitrogen (N2), argon (Ar), krypton (Kr), xenon (Xe), methane (CH₄), ethane (C₂H₆), propane (C₃H₈), including combinations of these various fluids, All pressures and temperatures that yield liquid, near-critical, or supercritical fluids for infusion of the LCP prior to foaming can be used. In addition, all fluid pressures that infuse molten LCP polymers with a surrounding fluid (e.g., krypton) to form a desired polymer foam upon expansion can be used without limitation. While supercritical fluids are described hereafter, the invention is not intended to be limited thereto. Exemplary supercritical fluids include Ar, CO₂, and N₂, which have relatively low and easily obtainable supercritical points. For example, argon (Ar) has critical points of −122° C. and 705 psi; carbon dioxide (CO₂) has critical points of 31° C. and 1071 psi. And, nitrogen (N₂) has critical points of −147° C. and 492 psi. The time required for infusion of the polymer with the fluidized gas will depend in part on the distance that the SCF has to diffuse from the outside of the polymer to the core of the polymer, and on how fast does this diffusion occurs.

The diffusion distance can be reduced in several ways including, e.g., by choosing the form of the polymer with a high surface area such as flakes/pellets/powder and by loosely packing the polymer flakes/pellets/powder. Having a high surface area for a given total volume of the polymer means that the SCF has more locations on the polymer from where it can diffuse into the flakes/pellets/powder particles, and hence, shorter time to saturation. The small physical size of an individual polymer flake/pellet/powder particle implies that the SCF only needs to diffuse a short distance, resulting in shorter time to saturation. Loosely packing the polymer flakes/pellets/powder particles ensures that the SCF can fill empty pockets between individual polymer flake/pellet/powder particles and thus surround each flake/pellet/powder particle from all sides and hence, the distance that the SCF has to diffuse in from any one external face of the flake/pellet/powder particle to its core is effectively halved.

### Liquid Crystal Polymers

Foams and composite foam structures of the invention include foams composed of liquid crystal polymer (LCP). While exemplary LCPs are described, the invention is not limited thereto. For example, all LCP foams that provide suitable mechanical properties in composite foam structures formed as detailed herein are within the scope of the invention without limitation. Thus, no limitations are intended. In some embodiments, the LCP polymer is a composite polymer as discussed and defined previously herein. In some embodiments, the composite foam can be formed from a LCP polymer known commercially as VECTRA™ B-130 LCP (Celanese Corporation, Dallas, Tex., USA), which contains about 30 wt % glass-fibers as a filler and a matrix consisting of B-950 polymer composed of 2,6-hydroxynaphthoic acid (HNA), p-aminophenol (AP), and terephthalic acid (TA) in a molar ratio of 60/20/20, respectively. Bulk density of VECTRA™ B-130 LCP is 1.6 g/cc, with a bulk elastic modulus of 22 GPa (see B-130 data sheet, available on the world wide web at: http://tools.ticona.com/tools/mcbasei/product-tools.php?sPolymer=LCP&sProduct=VECTRA). In other embodiments, the LCP polymer is a commercially available LCP known as VECTRA® A950 resin (Celanese Corporation, Dallas, Tex., USA), which is an aromatic polyester composed of 27% repeating units of 4-hydrobenzoic add and 73% repeating units of 6-hydroxy-2-naphthoic add. VECTRA® A950 resin LCP has a melting point (m.p.) of about 280° C. (data sheet for A-950 LCP polymer is available on the world wide web at: http://tools.ticona.com/tools/mcbasei/product-tools.php?sPolymer=LCP&sProduct=VECTRA).

### Solid Forms and Quantity

LCPs in any of a variety of solid state forms can be used. Exemplary solid state forms include, but are not limited to, e.g., chunks, pieces, pellets, flakes, granules, particles, and other dispersed forms. No limitations are intended. Pellets are a preferred solid form, but the method can employ all solid forms of the polymer. Formation of LCP foam and composite foam structures in accordance with the invention begins with weighing and delivering a selected quantity of LCP polymer into the container, structure, part, or mold to be filled. Mass of LCP needed to completely or partially fill the container may be calculated by dividing the volume (whether complete or partial) of the container to be filled by the density of the foam. In some embodiments, VECTRA® A950 LCP is used to fill a container. In the embodiment shown in FIG. 1, quantity of LCP used to fill the container volume with foam was ˜330 mg of VECTRA® A950 per mL, but quantities are not intended to be limited thereto. Quantity of LCP will vary depending on the container employed, structure to be filled, fill volume, polymer density, polymer viscosity and other foam related properties. No limitations are intended by the exemplary disclosures.

### Process for Forming LCP Foams and LCP Foam Structures

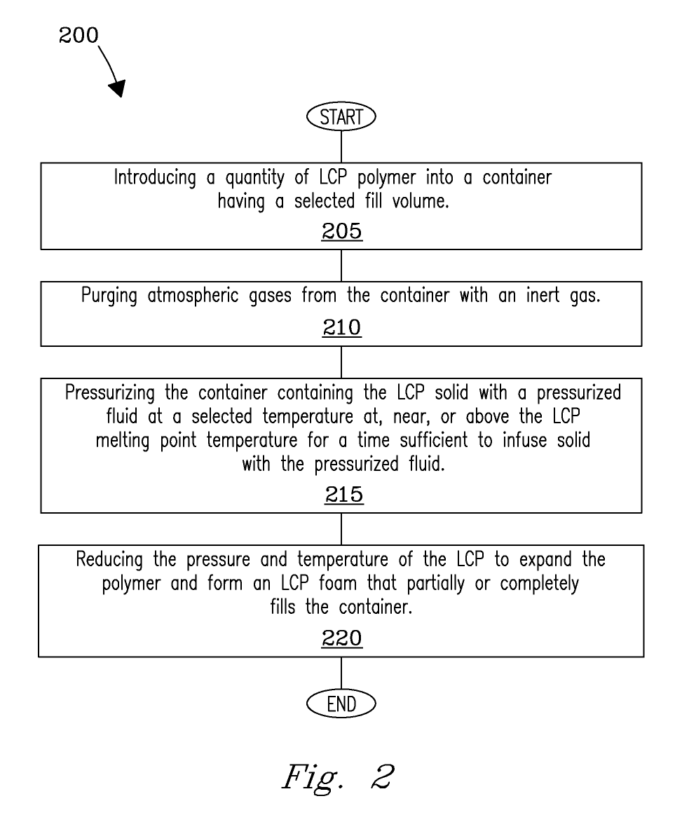

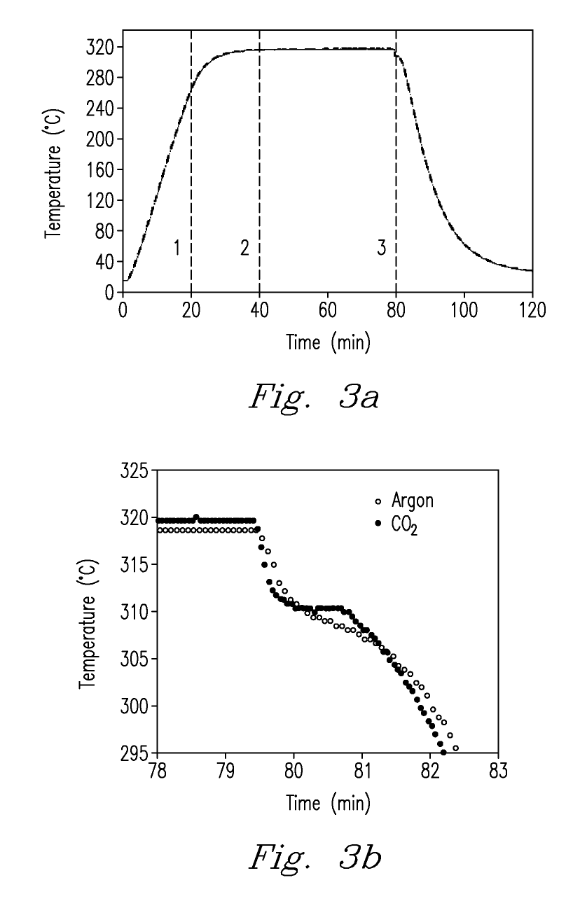

FIG. 2 presents an exemplary process 200 for forming LCP foam and composite foam structures, according to one embodiment of the invention. The process of the invention controls foaming conditions and production of foam within structures of various shapes, {Start Process}. In a first step {205}, LCP is placed into a container that is to be partially or completely filled. Containers are not limited and can include any of a variety of selected shapes. In the exemplary system of FIG. 1, fabrication of a typical LCP foam employs a quantity of LCP between about 200 g/mL and about 400 g/mL, but quantities are not intended to be limited thereto. For example, quantities of LCP will depend in part on the selected fill volume of the container, shape of the container, presence of reinforcing constituents and fillers in the LCP, other components present in the structure or composite structure, and other factors including, but not limited to, e.g., density and porosity of the desired foam. Thus, no limitations are intended to the exemplary embodiments. Next {210}, the container is purged with an inert purge gas (˜10 minutes) to remove atmospheric gases, which ensures that anaerobic conditions exist within the container prior to pressurization. This step minimizes the potential for degradation of the LCP at elevated temperatures. In another step {215}, the container is pressurized to infuse the LCP within the container with pressurized fluid (e.g., argon or CO₂) at selected liquid, near-critical, or supercritical fluid pressures at a suitable processing temperature (e.g., ˜320° C.). In some embodiments, temperature of the container is raised to the processing temperature, e.g., by heating at a selected rate. Heating rates are not limited. In one test, pressurized LCP was heated to the processing temperature at a rate of 15° C. per minute, a rate that maintained a close tie between the heat of the oven and the temperature of the LCP within the container, but conditions are not limited thereto. Heating facilitates diffusion of the fluidized gas into the molten LCP. In some embodiments, temperature is attained by introducing the pressurized container directly into the heating zone at the desired processing temperature until temperature equilibrium in the container is attained. Temperatures suitable for processing of LCP are variable. For example, in some embodiments, temperature suitable for processing is a temperature near (e.g., within ˜5 degrees Centigrade of) the melting point of the LCP polymer. In some embodiments, temperature suitable for processing is the melting point temperature. In other embodiments, temperature suitable for processing is above the melting point temperature. In a preferred embodiment, temperature of the polymer is typically between about 10 degrees Centigrade to about 20 degrees Centigrade above the melting point temperature of the polymer for a time sufficient to fuse the fluid-infused polymer. This step in the process assumes isothermal conditions are established within the container. In some embodiments, pressurization and heating are performed simultaneously. In some embodiments, pressurization and heating are performed serially. Once the LCP fuses into a single LCP mass, the LCP mass is indistinguishable whether the mass is prepared from solid pieces, solid chunks, or another solid form of LCP. Thus, while pellets are described, solid forms are not intended to be limited to any one type. In another step {220}, once the temperature selected for polymer expansion (e.g., 320° C.) is reached and isothermal conditions are established (˜20 to 30 minutes on average at a nominal heating rate of 10-15° C. per minute) [time (t₀)], pressure and temperature of the LCP (e.g., neat or composite r Fixture) are rapidly reduced (˜milliseconds) by releasing gas in the container to expand the LCP. Expansion of the neat or composite LCP partially or completely fills the container volume with LCP foam (see discussion for FIG. 3a), yielding the neat or composite LCP foam structure. In various embodiments, the resulting foam can have the shape of the container in which the foam is formed. {End Process}.

### Expansion and Foaming

Once the molten LCP is infused with the fluidized gas, the temperature and pressure exerted on the molten polymer is rapidly reduced to expand the polymer and form the LCP foam. This process releases gas bubbles from within the molten polymer, which expands the polymer and forms the foam within the container, structure, or part, yielding the LCP foam structure or composite foam structure.

### Thermal Processing of LCP Foams

FIG. 3a shows a typical thermal profile for expansion, depressurization, and cooling of LCP foam. In the figure, temperature data shown correspond to temperature measurements made in proximity of the LCP sample. Vertical lines in the graph mark events where: 1): the oven reaches 320° C. and marks the beginning of the stated processing time, 2): LCP samples reach 320° C. (about 20 minutes) and LCP samples remain at ˜320° C. for about 40 minutes, and 3): rapid depressurization and thermal cooling of foamed samples is initiated resulting in a LCP foam or foam structure. At the first vertical line (at 20 min.), a temperature of 280° C. is measured at the sample, while the oven is at 320° C. indicating a temperature lag is evident between the oven and the LCP sample. At the intersection of the thermal profile curve with the third vertical line, effects of rapid expansion cooling is observed, which is manifested as a small thermal depression (˜8-10°) in the curve. This thermal profile examines the temperature directly within the LCP pellets to give in-situ monitoring and insight as to the true heating and cooling rates, in addition to, the cooling effects of rapid depressurization of the expanding gas or fluid.

FIG. 3b shows an expanded view of the cooling curve of FIG. 3a at approximately 80 minutes into the process run showing cooling that occurs upon depressurization and expansion of the LCP foam. In the figure, cooling of LCP foam samples to room temperature generally follows the temperature profile of the oven, with some hysteresis. However, past the depression dip in the cooling curve, cooling of the thermalized polymer foam in the oven returns to the path dictated by the oven. CO₂ has a much sharper cooling effect than argon. CO₂ has a greater enthalpy requirement compared with argon at 320° C. and 4200 psi (i.e., CO₂=0.176 kcal/g) versus (Ar=0.073 kcal/g), which means more heat is removed by CO₂ during the polymer expansion that forms the polymer foam. And, freezing (solidification) of the foam structure occurs more readily with CO₂ compared to argon.

Temperature cooling rates during expansion are variable. However, those of ordinary skill in the art will appreciate that cooling is performed rapidly or at a sufficient rate such that, at higher temperatures, the mass of expanding LCP does not collapse and flow back together. Rates are thus selected that maintain the foam structure. In one exemplary test, a cooling rate of 50° C./minute was used during expansion while rapidly and simultaneously depressurizing. Any rate of cooling can be used provided the foam is cooled sufficiently rapidly to maintain the foam structure and prevent the foam structure from collapsing and flowing back together.

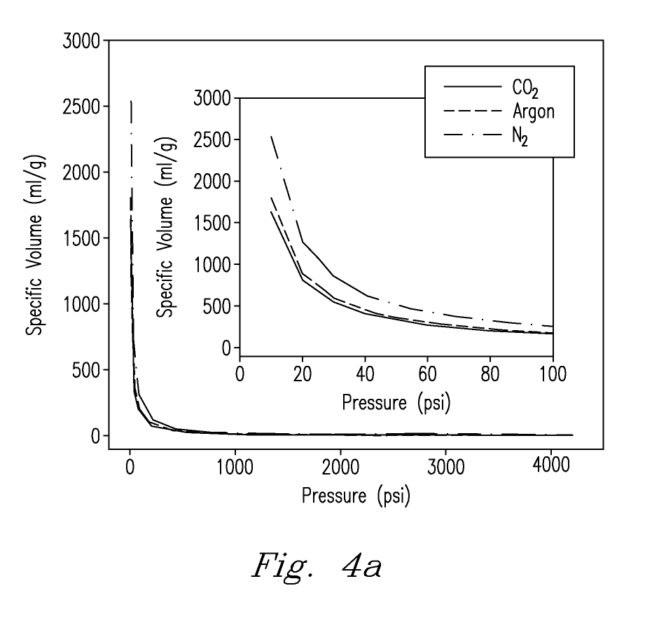

In some embodiments, LCP foam is made by infusing VECTRA B-130 pellets with argon or CO₂ (or another suitable gas) under supercritical conditions. VECTRA B-130 pellets contain about 30 wt % glass fibers (typical length below about 2 mm). In a preferred embodiment, expansion of the LCP to form the foam is preferably performed at a saturation pressure of 4200 psi and an expansion temperature of 320° C., but the invention is not intended to be limited thereto. For example, choice of saturation fluid affects formation of the LCP foam due to differences in the physicochemical properties of the fluids. Relevant fluid properties include, but are not limited to, e.g., volume expansion upon pressure (further discussed in reference to FIG. 4a below), heat transfer coefficient, viscosity, density, polarizability and combinations of these various properties. For example, polarizability affects foaming of the LCP and a lower relative polarizability is preferred. For example, the lower polarizability of argon (i.e., 1.6×10⁻²⁴ cm³) compared with nitrogen (1.7×10⁻²⁴ cm³) or CO₂ (2.9×10⁻²⁴ cm³) appears to give argon the ability to achieve a better nucleation of foam cells during large pressure drops that effects foaming of the molten LCP. Thus, the choice of saturation (infusion) fluid depends in part on the LCP selected and the anticipated cell structure of the desired foam. For example, CO₂ can cool a foam too rapidly to stabilize (freeze) the foam if the foam contains an open cell structure (see FIG. 3b). And, foams with an open cell structure yield a lower compression property and performance. Conversely, for LCP polymers having a greater viscosity, the quicker cooling achieved with CO₂ can prove beneficial because the LCP foam structure does not melt and collapse upon itself after foaming occurs. In short, gas and expansion conditions best suited to a selected LCP will depend in part on the part or shape to be filled, desired cell structure of the resulting foam (i.e. open vs. closed cell foams), and desired mechanical properties.

### Fluid Viscosity and Structure of LCP Foams

Fluid viscosity affects the resulting structure of the LCP foams. FIGS. 4a-4b compare volume and viscosity changes of common supercritical fluids as a function of pressure and temperature. In FIG. 4a, nominal differences in specific volume expansion for CO₂ and Ar are observed when transitioning from a pressure of 4200 psi to atmospheric pressure (or 14.7 psi). However, as shown in FIG. 4b, Ar has an ˜30% greater viscosity than CO₂ or N₂ when transitioning from a pressure of 4200 psi to atmospheric pressure (or 14.7 psi). These viscosity differences can be exploited to impact the expansion of the molten LCP that forms the LCP foam. For example, Ar induces foaming at a slower, more constant, rate leading to a better uniformity in pore structure. Lower fluid viscosities are preferred, but are not limited thereto.

### Expansion and Foam Properties

Rate at hich pressure and temperature are reduced during foam expansion impacts properties of the foam. For example, if temperature is decreased too slowly during release of pressure or vice versa, then gas bubbles within the LCP (and thus the LCP foam) can collapse and the ability to foam the LCP into the desired end shape can be lost. Properties vary slightly depending on the type of LCP used and the container or structures to be filled. Thus, in typical operation, temperatures during expansion in the container are preferably above the melting point temperature of the LCP, which allows the LCP to foam properly. LCP when melted has a significantly lower viscosity and greater permeability to a fluidized gas than when LCP is in the non-melted state. The greater permeability in the melted state is attributed to more fluidized gas being absorbed by the LCP when the temperature is greater than the melting point (m.p.) temperature. The reduced viscosity of molten LCP allows gas bubbles in the fluid-infused polymer to expand. Thus, a lower viscosity of LCP when above the melting point temperature enables it to foam properly. If viscosity of the LCP is too high, e.g., when temperature is less than the melting point temperature of the polymer, or too much of the solid LCP phase remains in the container, the melt may prevent bubble expansion (i.e., may be too “strong”) and therefore not expand properly. In contrast, when LCP is above the melting point temperature, and thus in a liquid form, viscosity of the LCP decreases incrementally with every incremental increase in temperature. In some embodiments, sandwich composite structures are formed with LCP foams, where further process steps are required, as will be understood by those of ordinary skill in the polymer foam and manufacturing arts. No limitations are intended.

### Depressurization

Depressurization rate is controlled such that the foam expansion fills the container, structure, or part with the LCP polymer foam to the desired fill level that further yields the desired structure, shape, and/or mechanical properties. Rates for depressurization are variable. Thus, no limitations are intended. For example, pressure exerted on the LCP foam is released at a controlled rate while incrementally decreasing the temperature at a controlled rate to promote controlled growth of foam cells within the forming LCP foam. If temperature is not decreased, or if temperature is decreased too slowly, gas bubbles within the expanding LCP can collapse, producing a foam that does not fill the container or does not have the desired shape of the container, structure, or part. In one exemplary test, rate of depressurization was instantaneous. In this test, pressure was dropped from 4200 psi to 1500 psi in one second. In this test, the polymer was rapidly expanded such that foam cells were formed before they were cooled into place within the selected structure.

### Tailoring Properties of LCP Foams and Composite LCP Foam Structures

LCP foams of the invention can be tailored to include selected properties t compare favorably with metal (e.g., aluminum) foams. For example, in some embodiments, mechanical properties are tailored so LCP foams are suitable for light-weight and/or structural support applications. In other embodiments, enhanced energy absorption properties are tailored so LCP foams are suitable for ballistic, blast, and other high impact applications. In other embodiments, acoustical and vibrational energy adsorption properties are tailored so LCP foams are suitable for acoustical and vibrational energy adsorption applications. In yet other embodiments, thermal insulation properties are tailored so LCP foams are suitable for high-temperature applications. Some embodiments make advantageous use of multiple properties. For example, in some embodiments, LCP foams and foam composites are employed in automotive body parts as high strength reinforcements, sound barriers (i.e., for sound reduction), thermal insulators (i.e., for thermal insulation) that keeps the interior cabin hot or cool thereby increasing the thermal efficiency of the auto body, including combinations of these various properties. No limitations are intended. All properties of LCP foams as will be tailored by those of ordinary skill in the art in view of the disclosure are within the scope of the invention.

In some embodiments, LCP foams and composite foams of the invention include excellent sound and vibration absorption properties. These advantageous properties are due in part to the porosity of the foam and composite foam that provide very low acoustical and vibration transmission.

In some embodiments, LCP foams of the invention (and composite of such) include excellent thermal insulation properties. These advantageous properties arise from the combination of low thermal conductivity typically provided by the polymeric backbone and the high porosity of foam materials that results in very low poor conduction of thermal energy. Thermal and acoustical absorption with light, high strength materials has a number of applications; including many in the transportation sector.

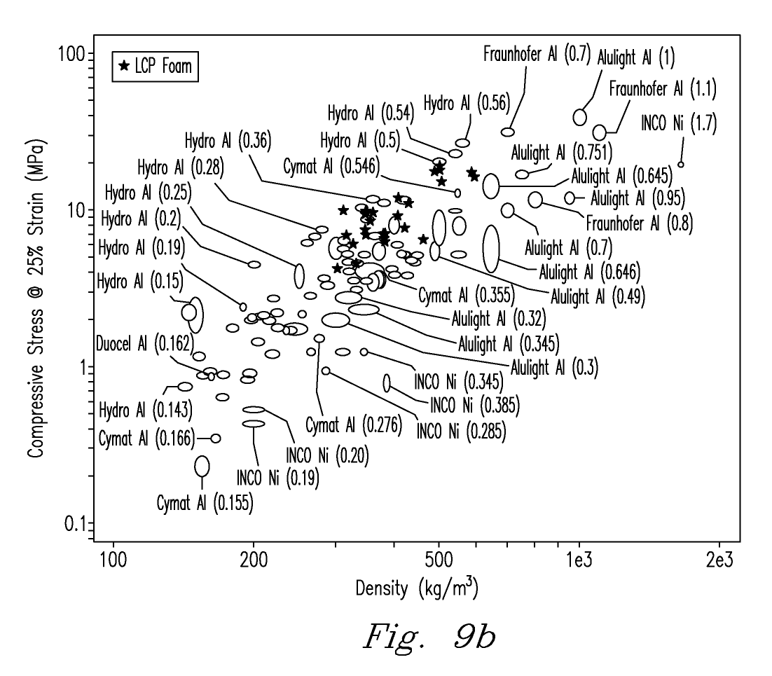

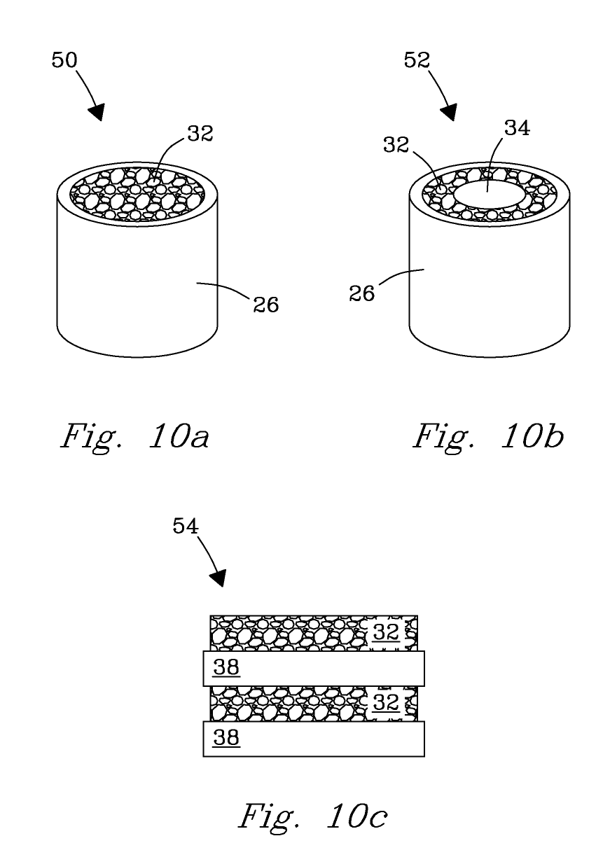

In some embodiments, materials and methods of the invention described herein have advantageous application to ballistic and high impact structures. For example, in some embodiments, LCP foams of the invention include a high specific compression strength (i.e., greater than about 20 MPa·cc/g) suitable, e.g., for compression and composite compression parts, components, structures, devices, and associated applications. Examples include, but are not limited to light-weight compression structures and components. In other embodiments, parts containing LCP foam include a compression strength suitable for use in ballistic and blast protection structures including, e.g., body and transportation armors suitable for military and other protection applications; shielding, e.g., for land-based vehicle and air-based transport applications; and high impact structures for destructive and non-destructive impact applications including, e.g., vehicle panels, impact and compression bumpers, e.g., for cars and other transportation vehicles, other impact structures, as well as energy absorbing structures and structural components. Compression performance can be characterized by assessing the yield stress, the modulus, the plateau stress, and/or the densification strain, which determine the energy absorbed (described further in reference to FIG. 9a below).

In some embodiments, LCP foams of the invention include energy absorption properties suitable for use in impact resilient structures, parts, components, structures, devices, and associated applications.

In some embodiments, LCP foams of the invention are added as fillers, e.g., for hollow parts, to improve performance, e.g., by providing stiffness against buckling of a part, enhancing energy absorption, providing noise reduction, acting as a thermal or insulation barrier, or combinations of these various properties.

In varied applications, LCP foams of the invention can substitute for metal-based foams because mechanical properties of the LCP foams including, e.g., compressive strength, modulus, energy absorption, and/or energy densification are equivalent to, or better than, those of metal foams.

In various embodiments, materials and methods of the invention described herein have advantageous applications in transportation systems including, e.g., vehicles (e.g., automobiles, aircraft, and boats) that provide strong, rigid, light-weight, and energy absorbing components.

In some embodiments, materials and methods of the invention described herein have advantageous application to chemical separation, filtration and catalysis. For example, the extraordinary strength, porosity, and thermal stability of LCP foams provide light and robust materials suitable for applications including, but not limited to, e.g., chemical separations, filtration, membrane processes, and catalyst supports. Surface modification, using methods commonly known, enable the addition of chemical selectivity or catalytic activity. In various embodiments, ability to generate neat and composite foams directly into various support shapes enables construction of chemical processing media in desired and selected configurations.

### Mechanical Properties of LCP Foams

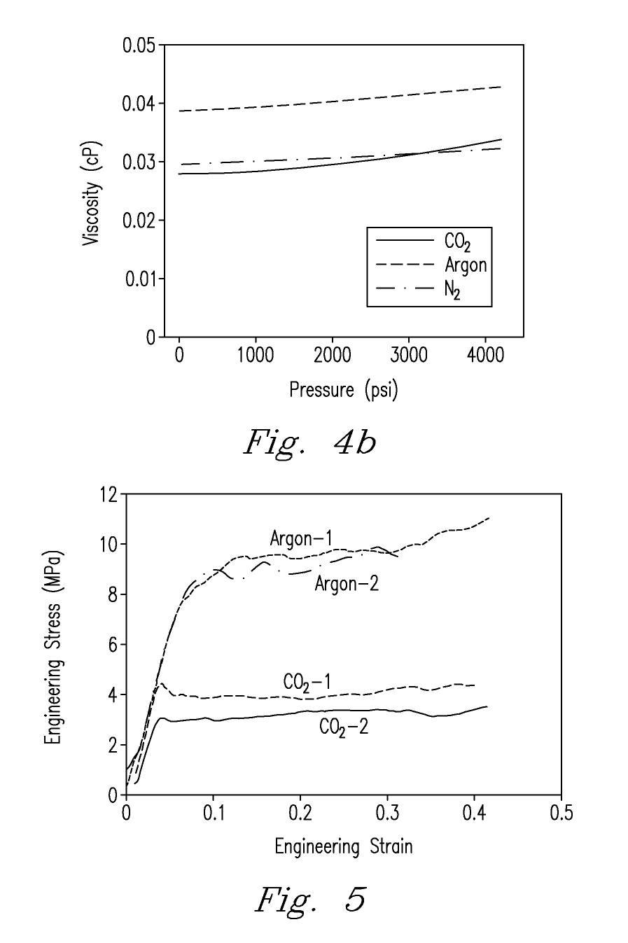

Foams of the invention were fabricated and tested by systematically adjusting variables such as processing temperature, supercritical fluid, saturation time, pressure, and thermal aging. Foams produced with supercritical Ar exhibit various morphological differences compared with foams produced with supercritical CO₂. Infusion of the polymer with supercritical Ar prior to expansion and foaming produced a more uniform foam morphology compared with supercritical CO₂ foams. In addition, foam samples produced with Ar showed a greater mechanical performance. Processing with Ar gave mostly closed cells with sizes that varied between about 50 μm to about 100 μm. Processing with CO₂ showed the same relative pore sizes but with a more torturous open cell geometry. Mechanical properties of these LCP foams were then evaluated by compression testing the foam samples. In general, mechanical properties of LCP foams compare favorably with metal foams including, but not limited to, e.g., energy absorption and compressive strength. FIG. 5 compares compressive stress-strain curves for LCP foams of the invention formed using supercritical argon and supercritical CO₂. As shown in the figure, foams produced with supercritical Ar have ˜2.5× times the compressive strength of foams produced with supercritical CO₂. Maximum compressive strength in LCP foams produced with Ar was obtained by infusing the LCP for one hour at a pressure of 4200 psi and a temperature of 320° C., followed by rapid (˜instantaneous) depressurization and expansion and cooling of the LCP foam. In some embodiments, pressure drops from about 4200 psi to about 1500 psi in about 1 second, which expands the saturation fluid as a gas, which expands the LCP polymer to form the LCP foam product. Rapid fluid expansion also draws heat from the system, which cools the foam product (see discussion FIG. 3b).

### Mechanical Strength of Liquid Crystal Polymers

Mechanical strength of LCP polymers and LCP foam structures and articles is a function of the alignment of the molecular chains of the polymer relative to the load direction. Alignment of the molecular chains results in a tensile strength and tensile modulus that is highest along the load direction. Tensile strength and tensile modulus are rawer if the alignment of the molecular chains is not parallel to the direction of the load. For example, when molecular chains in an LCP are aligned along the loading direction, the tensile strength and modulus of the LCP can be as good as, or better than, the mechanical properties of metals. Alignment of the molecular chains occurs by during the expansion of the LCP mass that forms the LCP foam. In general, stretching the polymer chains helps to align chains and increase strength. Molecular alignment of the LCP is achieved both during the formation of the foam and during post processing of the foams and foam structures. Thus, LCP foam may produce articles of low or high strength depending upon the degree of molecular alignment achieved. The compressive modulus (or stiffness) of LCP foams is proportional to the modulus of the unfoamed precursor and the relative density of the foam, i.e. density of foam divided by the density of the solid precursor. The strength and modulus of LCP foams can be enhanced to exceed the strength and modulus of Al foams through molecular alignment (via the foam process described and selection of additives to the LCP). Thus, the strength and modulus of LCP foams can be made to exceed those of Al foams having the same foam density. LCP foams that include a high degree of molecular alignment within the cell walls of the foam will be lighter than a conventional Al foam having a similar strength and modulus. Strength of the LCP polymer is also a function of constituents or additives present in the composite foam and/or other structural elements (e.g., panels or supports) included as components of the composite foam structure including, e.g., an encapsulating mold. By optimizing foam properties, LCP foams and composite foams and structures made from such foams can achieve strengths similar to, or greater than those of metal foams, as detailed below.

### Fluid Infusion on Foam Properties

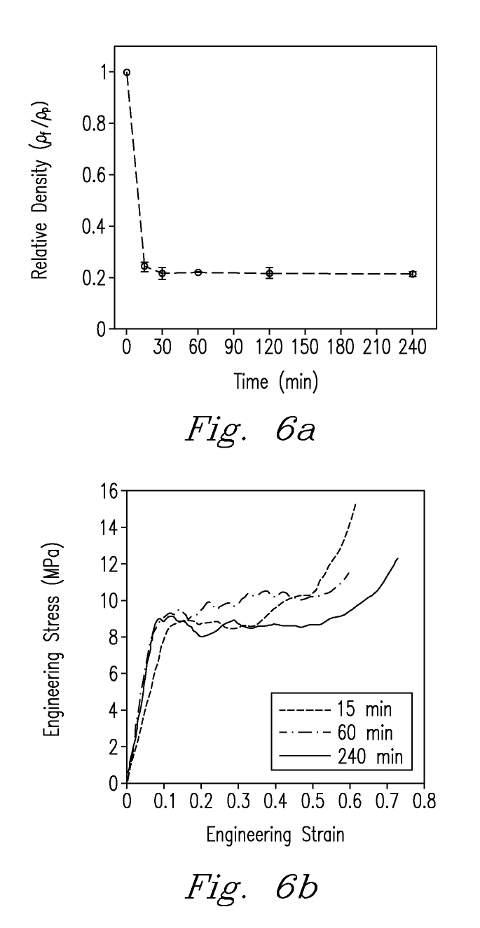

Impact of fluid saturation (infusion) time prior to foaming was also explored to test when optimum saturation of the LCP was reached. Compression strength was used in determining the optimum conditions. FIG. 6a compares relative density [defined as the density of the foam (ρ_{f}) divided by the density of the bulk LCP polymer (ρₚ)] of various foams as a function of processing time. In the melt state, when the LCP is a semi-crystalline polymer, gas diffusion and permeation increases significantly. In the figure; after 15 minutes at fluid saturation conditions, relative density of the foamed LCP is just under 0.25, which is close to the consistent relative density of 0.22 obtained at greater saturation times. After about 30 minutes, no appreciable change in relative density is obtained for the glass-filled VECTRA B-130 composite foam, indicating that infusion of supercritical Ar occurs within ˜30 minutes (for 4200 psi and 320° C.). FIG. 6b shows selected stress-strain performance curves of VECTRA B-130 LCP foams at various processing times. All samples show similar mechanical performance curves with a small increase in the densification strain observed with increasing processing time. As all samples examined had similar relative densities, the densification effect may reflect the overall pore structure within each foam sample.

TABLE 1 lists mechanical properties (including specific modulus, specific strength, and specific energy absorption) of various foams as a function of saturation time with argon (Ar) at 320° C. and 4200 psi.

TABLE 1
Mechanical properties of VECTRA B-130 LCP foam samples
processed at various times with argon at 320° C. and 4200 psi.

| | | | | | | Specific energy |
|---|---|---|---|---|---|---|
| | | | | | | absorbed at |
| Processing | Foam | Compressive | Densification | Specific | Specific | densification |
| time | density* | stress at yield* | strain* | strength* | modulus* | strain* |
| (mins) | (g/cc) | (MPa) | (%) | (MPa · cc/g) | (MPa · cc/g) | (J/g) |
| 15 | 0.41 | 13.3 | 51 | 32.3 | 432 | 16.4 |
| 30 | 0.35 | 9.3 | 50 | 27.0 | 284 | 14.0 |
| 60 | 0.35 | 8.4 | 54 | 24.4 | 453 | 13.4 |
| 120 | 0.35 | 8.3 | 56 | 24.0 | 353 | 13.5 |
| 240 | 0.35 | 8.5 | 53 | 24.7 | 391 | 13.0 |

*Values are averages of three compression samples, except data at 15 minutes, which averages two samples.

Data in TABLE 1 show that the shortest processing time (15 minutes) results in the highest specific strength and specific energy absorbed at the densification strain. With further increases in processing time, the specific strength and specific energy absorbed at densification strain gradually decrease and are relatively insensitive for processing times of 60 minutes or longer. Results suggest that fluid infusion into the LCP for a period time between about 30 minutes and 60 minutes yields a uniform density and other properties. Specific modulus values do not show a consistent trend with processing (i.e., fluid infusion) time, but can be determined empirically.

### Impact of Pressure on Foam Processing

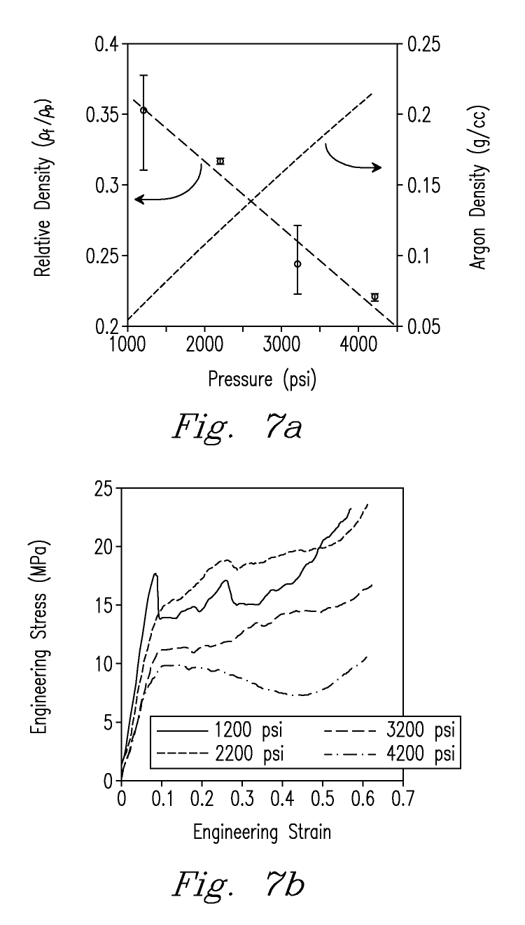

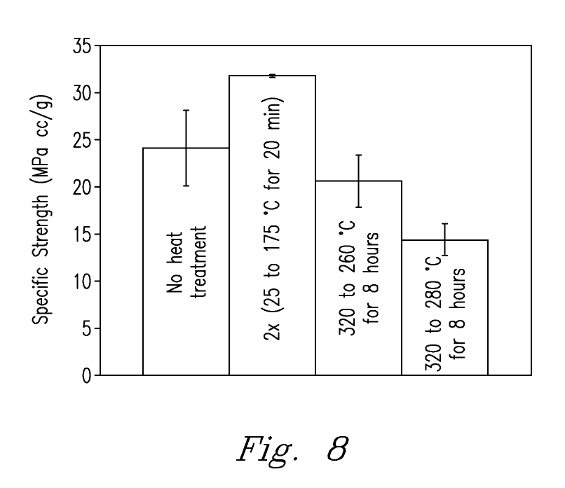

FIG. 7a shows effects of foaming pressure on relative foam density of various foams produced in accordance with the invention at varying processing pressures. An inversely proportional relationship is observed between argon fluid density and relative foam density. In particular, as pressure or density of argon is increased, a decrease in relative foam density occurs. Thus, the greater the amount of supercritical fluid absorbed into the LCP, the greater the expansion of the polymer when depressurized. Data show that higher pressures can result in lower density LCP foams, although fluid saturation within the LCP can reach a maximum point above which pores can be expected to expand beyond their ability to deform. At that point, structure of foam cells will be severely fractured leading to a fractured or torn structure with low mechanical performance and very low density. As will be understood by those of ordinary skill in the art, all fluid saturation conditions below the fracture point (point above which fluid volume expansion fractures the foam structure), FIG. 7b shows typical stress-strain curves for compression tested foams as a function of foaming pressure. TABLE 2 lists mechanical values from compression tests on VECTRA B-130 foam samples each processed with argon (Ar) at 320° C. at various pressures for one hour.

TABLE 2
Mechanical properties of VECTRA B-130 LCP foam samples
processed with argon at 320° C. at various pressures for one hour.

| | | | | | | Specific energy |
|---|---|---|---|---|---|---|
| Processing | Foam | Compressive | Densification | Specific | Specific | absorbed at |
| pressure | density* | stress at yield* | strain* | strength* | modulus* | densification |
| (psi) | (g/cc) | (MPa) | (%) | (MPa · cc/g) | (MPa · cc/g) | strain* (J/g) |
| 1200 | 0.57 | 19.3 | 52 | 34.4 | 403 | 18.1 |
| 2200 | 0.51 | 16.3 | 48 | 32.2 | 338 | 15.4 |
| 3200 | 0.41 | 9.8 | 50 | 23.8 | 328 | 11.9 |
| 4200 | 0.35 | 8.4 | 54 | 24.4 | 453 | 13.4 |

*Value reported is an average of three compression samples, except 3200 psi data which averages two samples.

As shown in TABLE 2, increasing foaming pressures from 1200 psi to 3200 psi results in decreasing values for specific strength, specific modulus, and specific energy absorbed at the densification strain. An increase in pressure from 3200 psi to 4200 psi improves these stated properties slightly. In general, results show that pressure can be used to tailor mechanical properties of LCP foams.

### Thermal-Aging Effect on Mechanical Performance

Thermal heat treatments applied immediately after foaming were explored as a means to improve mechanical performance. In one test, after expansion that formed the foam, foam was cooled (e.g., from 320° C. to room temperature), and then thermally aged. Foam was aged by twice cycling the temperature of the foam from 22° C. to 175° C., TABLE 3 lists exemplary data for thermally-aged LCP foams.

TABLE 3
Mechanical properties of thermally aged VECTRA B-130 LCP foam
samples.

| | | | | | | | Specific |
|---|---|---|---|---|---|---|---|
| | | | | | | | energy |
| | | | | | | | absorbed at |
| Aging | Aging | Foam | Compressive | Densification | Specific | Specific | densification |
| temp. | time | density* | stress at yield* | strain* | strength* | modulus* | strain* |
| (° C.) | (min.) | (g/cc) | (MPa) | (%) | (MPa · cc/g) | (MPa · cc/g) | (J/g) |
| none | none | 0.35 | 8.4 | 54 | 24.4 | 453 | 13.4 |
| 2X (175) | 2X (20) | 0.38 | 11.9 | 55 | 31.8 | 336 | 17.6 |

*Value is an average of three compression samples. Processing was performed at 4200 psi and 320° C. for one hour with subsequent thermal aging.

A comparison of heat-treated and non-heat treated foams in TABLE 3 shows that heat-treatment resulted in improvements in specific strength and specific energy absorption properties, though at the expense of lowering the specific modulus. Heat treatment appears to promote amorphous polymer chains to rearrange into crystals, resulting in improvements in mechanical properties of the resultant foams.

In another test, LCP foams were thermally aged immediately following expansion and formation of the polymer foam at 320° C., at a temperature of either 260° C. or 280° C. and without letting the foam cool to room temperature prior to aging. TABLE 4 lists compression data for foams thermally-aged by this aging approach.

TABLE 4
Mechanical properties of thermally aged LCP foam samples, where
aging was performed while cooling from the foaming temperature of 320° C.

| | | | | | | | Specific |
|---|---|---|---|---|---|---|---|
| | | | | | | | energy |
| | | | Compressive | | | | absorbed at |
| Aging | Aging | Foam | stress at | Densification | Specific | Specific | densification |
| temp. | time | density* | yield* | strain* | strength* | modulus* | strain* |
| (° C.) | (hours) | (g/cc) | (MPa) | (%) | (MPa · cc/g) | (MPa · cc/g) | (J/g) |
| 260 | 8 | 0.42 | 8.6 | 65 | 20.6 | 391 | 13.5 |
| 280 | 8 | 0.32 | 4.6 | 60 | 14.4 | 198 | 8.6 |

*Value is an average of three compression samples, except data at 280° C., which averages data from two compression samples. All samples were processed at 4200 psi and 320° C. for one hour with subsequent thermal aging.

At these aging temperatures, thermal aging promotes crystal formation just at, or below, the bulk LCP melting point of ˜280° C.

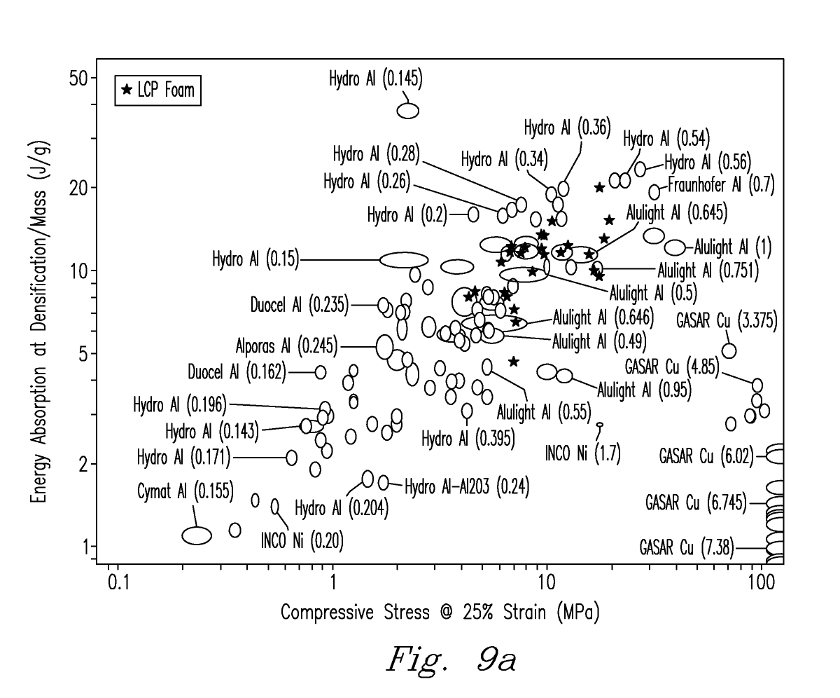

FIG. 8 plots specific strength for foams aged by the first and second aging approaches discussed above. In general, data show that thermal aging of post-foamed structures after cooling to room temperature is a preferred route for increasing mechanical properties of the foams, but such processing is not limited thereto as shown herein. Results indicate that rapid cooling can form more cell nuclei in the foam, as evidenced by processing performed using the first aging technique (see TABLE 3). Coupling a greater number of nuclei from rapid cooling with sequential and cyclic heating of the foamed samples to 175° C. (twice), gave better specific strength and greater specific energy at densification strain, attributed to greater crystal formation, Supercooling also helps to initiate crystal nucleation and growth, which in turn, increases the complex modulus. Supercooling can also help increase favorable properties by increasing the number of nuclei, which helps to grow many smaller crystals during thermal treatments, as opposed to a few larger ones. Since the melting point of VECTRA B-130 is ˜280° C., then examination of the aging effects at melting (280° C.), and when supercooled into the solid-state (260° C.) were explored. However, foam samples aged at either 260° C. or 280° C. showed a decrease in mechanical properties. No increase in compression properties were observed after foaming at 320° C. with an additional 8-hour thermal dwelling time at temperatures of 260° C. or 280° C. The aging isotherm generated by the thermal aging approach appears to dictate overall mechanical performance, attributed to controlled nucleation and growth of crystals in the LCP foam. A method that employs additional thermal processing can be conducted, e.g., as outlined in TABLE 3 (line 2) to improve mechanical properties of the LCP foam. If additional thermal processing is not desired. LCP foams can be made without thermal cycling, e.g., as outlined in TABLES 1 or 2.

### Energy Absorption of LCP Foams

FIG. 9a plots data for energy absorption at densification per unit mass as a function of compression stress at 25% strain for LCP (e.g., VECTRA B-130) foams of the invention (star symbols) against data for commercial metal (e.g., aluminum, nickel, and copper) foams (ellipse symbols), Randomly selected ellipse symbols are labeled with the name of the manufacturer, the metal (Al, Ni, Cu) of which the foam is made and the foam density (in parenthesis in units of g/cc). Data for metal foams were plotted using CES Selector software version 5.2.0 (Granta Design Limited, Cambridge, UK) with data for LCP foams of the invention superimposed. Area for each ellipse represents the range of values such foams may possess while the LCP foam (star symbols) represent a discrete data point. Normalized energy absorption data for LCP foams can thus be compared against data for conventional aluminum and other metal foams.

FIG. 9b compares compressive strength as a function of density for LCP (e.g., VECTRA B-130) foams of the invention against commercial metal (e.g., Al, Ni, and Cu) foams. Star symbols (for LCP foams) and ellipse symbols (for commercial metal foams) used in the figure have an identical meaning as those described in reference to FIG. 9a above. Fabrication conditions for LCP foams presented in FIG. 9a and FIG. 9b are listed in TABLE 5 below.

TABLE 5
Fabrication parameters and corresponding properties for VECTRA
B-130 LCP foams generated in accordance with the invention
processed with argon gas and saturated at 320° C.

| | | | | Energy | |
|---|---|---|---|---|---|
| | | | | Absorption | |
| | | | | per Unit | Compressive |
| | | | | Weight at | Strength at |
| Pressure | Time | Heat Treatment | Density | Densification | 25% Strain |
| (psi) | (min) | after Foaming | (Kg/m³) | (J/g) | (MPa) |
| 4200 | 60 | 8 hr. @ 260° C. | 420 | 12.2 | 7.87 |
| 4200 | 60 | 8 hr. @ 260° C. | 380 | 12.4 | 6.74 |
| 4200 | 60 | 8 hr. @ 260° C. | 460 | 8.0 | 6.55 |
| 4200 | 60 | 8 hr. @ 260° C. | 329 | 8.4 | 4.60 |
| 4200 | 60 | 8 hr. @ 260° C. | 301 | 8.0 | 4.32 |
| 4200 | 240 | None | 326 | 10.7 | 6.17 |
| 4200 | 240 | None | 355 | 9.9 | 8.61 |
| 4200 | 120 | None | 384 | 8.3 | 6.43 |
| 4200 | 120 | None | 315 | 11.7 | 6.83 |
| 4200 | 120 | None | 345 | 11.6 | 7.58 |
| 4200 | 60 | None | 345 | 7.3 | 6.99 |
| 4200 | 60 | None | 345 | 13.6 | 9.39 |
| 4200 | 60 | None | 345 | 13.6 | 9.69 |
| 4200 | 30 | None | 310 | 15.3 | 10.61 |
| 4200 | 30 | None | 358 | 11.6 | 9.70 |
| 4200 | 30 | None | 382 | 4.7 | 7.07 |
| 4200 | 15 | None | 409 | 11.9 | 9.42 |
| 4200 | 15 | None | 413 | 12.3 | 12.39 |
| 3200 | 60 | None | 434 | 11.7 | 11.78 |
| 3200 | 60 | None | 382 | 6.5 | 7.30 |
| 2200 | 60 | None | 508 | 15.3 | 19.51 |
| 2200 | 60 | None | 503 | 13.2 | 18.46 |
| 2200 | 60 | None | 510 | 11.5 | 15.79 |
| 1200 | 60 | None | 593 | 9.6 | 17.51 |
| 1200 | 60 | None | 497 | 20.1 | 17.75 |
| 1200 | 60 | None | 603 | 10.0 | 16.65 |

In general, LCP foams of the invention exhibit foam properties that compare favorably with aluminum foams. These data suggest LCP foams have the potential to be used in applications where aluminum foams are currently employed. Composite materials prepared in accordance with the invention also have numerous potential applications, e.g., as structural fillers for automotive parts including, e.g., window pillars, bumpers, and/or undercarriage parts or applications where energy absorptive capabilities are required.

### Foam and Composite Foam Structures

LCP foams of the invention (including neat LCP and LCP with added constituents) can be tailored to produce foam and composite foam structures, parts, and articles having a variety of shapes and forms for desired applications. While representative structures will now be described, those of skill in the art will recognize that many varied structures can be constructed in accordance with the present invention. Thus, the invention is not intended to be limited to the representative structures. All foam structures as will be constructed in view of the disclosure are within the scope of the invention.

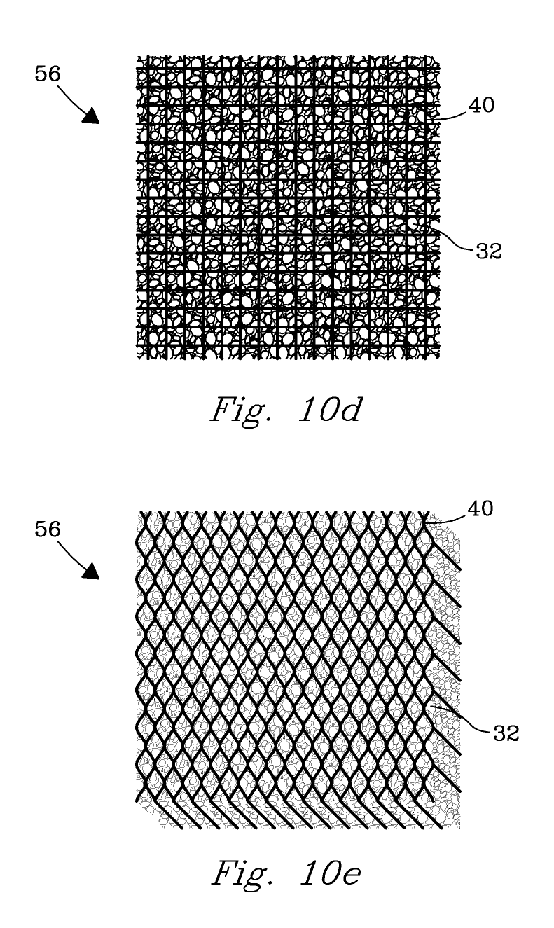

FIGS. 10a-10e show representative foam and composite foam structures, according to different embodiments of the invention. FIG. 10a shows an exemplary foam structure 50 of a completely filled type, defined by a container 26 filled with LCP foam 32. In general, LCP foams and composite foams prepared in accordance with the invention can be expanded to fill containers of various types, shapes, and forms. Examples include, e.g., shaped parts, molds, supports, or other containers composed of various structural components and materials that when filled with LCP foams or LCP composite foams of the invention yield composite foam structures, parts, and articles.

FIG. 10b shows another exemplary foam structure 52 of a partially filled type. In the figure, container 26 includes an embedded component 34 (e.g., tubes, channels, patterned structures, or other embedded components) that is not filled with foam. LCP foam 32 that is expanded (or otherwise positioned or constructed) around embedded component 34 partially fills container 26 of structure 52. Component 34 thus defines a hollow portion within the resulting foam structure 52. Examples of hollow foam structures, foam articles, and foam parts include, but not limited to, e.g., tubular foam structures, channel foam structures, in-channel foam structures, interconnected (e.g., honey-comb) foam structures, and combinations of these various hollow foam structures. The ability to fill or construct hollow foam structures around, or embedded with, rigid structural components (e.g., tubes, channels, panels, or other rigid structures) yields foam and composite foam structures that are light weight, have a reduced weight, and further include all of the advantages associated the rigid components. In addition, LCP foams of the invention can provide other favorable properties including, e.g., energy absorption, compression, and strength properties to the foam and composite foam structures.

FIG. 10c shows an exemplary laminate (sandwich) foam structure 54. Structure 54 includes sections or blocks of LCP foam 32 or composite foam 32 constructed or formed in accordance with the invention that are alternated with solid panels 38 or another structural element. In some embodiments, the laminate structure can include hollow (i.e., not foam filled) or embedded portions as described previously herein. In some embodiments, composite structures may be formed by foaming (or placing) LCP foam or LCP composite foam between planar or nonplanar elements forming, e.g., sandwich composite structures or other layered composite structures. In various embodiments, layered structures combine the advantages of planar or nonplanar structural materials including, e.g., metal plates or sheets that are, e.g., corrosion or abrasion resistant, or hard ceramic materials that provide ballistic, protection, or other advantageous properties, with equally important support and energy absorption properties provided by the LCP foam or composite foam. Layered materials can further be assembled into a complex laminate structure. No limitations are intended. In some embodiments, the container (e.g., molds, supports) and structural components (e.g., panels, patterns, fabrics, meshes,) remain in place as a component or part of the resulting foam structure. In some embodiments, the structural component (e.g., a mold) is present during foaming and then subsequently removed. In some embodiments, composite structures may be formed by foaming the LCP into a mesh material, fabric (e.g., a flexible and strong fabric), or pattern (e.g., honeycomb pattern, square pattern, or other patterned structure) that provides the resulting composite with the advantages of the mesh, fabric, or pattern with the strength, support, compression, and energy absorption properties of the foam.

FIG. 10d shows an exemplary composite foam structure 56 of a pattern type. Structure 56 includes an embedded pattern 40. In the instant embodiment, pattern 40 is of a square pattern type, but is not limited thereto. Pattern 40 is filled (partially or completely) with LCP foam 32 or composite foam 32. Patterns include, but are not limited to, e.g., meshes, grids, shaped patterns, and other patterned materials. No limitations are intended. In some embodiments, LCP is foamed into a mesh or mesh-like structures to form foam composites containing polymer mesh and like materials. Mesh materials can also be composed of materials including, but not limited to, e.g., carbon nanotubes, mats, polymer fiber, polymer weaves, fiberglass, metal meshes, including combinations of these various materials. Shapes and formats are not limited. In some embodiments, foam is used to fill structured fabrics, meshes, and/or grids (e.g., a fiber grid), yielding a composite foam structure that includes the mesh, the structured fabric, or the structured grid. In various embodiments, structured foam composites may be constructed having selected energy absorption and mechanical strength properties as described herein.

FIG. 10e illustrates another exemplary composite foam structure 56 of a pattern type. Structure 56 includes an embedded pattern 40 of a honeycomb pattern type that may be filled (partially or completely) with LCP foam 32 or composite foam 32. In some embodiments, composite structures can be formed by foaming the LCP foam within a honeycomb (i.e., cross-hatched) structure, where the honeycomb backbone (or other support type) that provides the necessary structural support and the foam that provides, e.g., a desired energy absorption or compression capability. Components used as structural supports are not limited, and can be of any dimension and shape. In some embodiments, foam structures of the invention include molded foam structures, machined foam structures of various shapes, including combinations of these various foam structures and molded foam parts. The ability to form composite structures with the versatility of including both foam and structural elements provides the resulting foam structures with the structural advantages provided by the bounding or embedded structures and the strength, compression, and/or energy absorption properties and capacities of the LCP foams or composite foams.

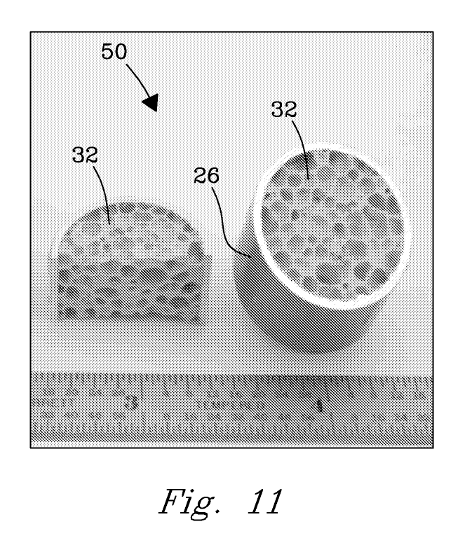

FIG. 11 is a photo of a LCP foam structure 50 formed in accordance with the invention of a completely foam filled type. In the figure, container 26 is an aluminum tube 26 that is completely filled with LCP foam 32. The structure is representative of various LCP foam and composite foam structures, parts, shaped parts, molded parts, articles, and other structural components that can be made in accordance with the invention. In the figure, a hollow aluminum (Al) tube [dimensions: 0.875 in. O.D.; wall thickness: 0.0625 in.] was filled with VECTRA A-950® LCP polymer. LCP foam was formed using fluidized argon (Ar) at a pressure of 4200 psi and a temperature 320° C. for 1 hour prior to foaming. No limitations are intended to exemplary structures described herein. All materials, parts, and components as will be implemented or made by those of ordinary skill in the art in view of the disclosure are within the scope of the invention.

### Example

˜400 mg of pellets of VECTRA-B130 LCP 24 were placed inside a glass vial container 26 (dimensions ˜35 mm in length and outer diameter of ˜8 mm). Pellets filled vial container 26 up to approximately half the available height. Glass container 26 was placed inside a high pressure containment vessel 22 that was connected to a stainless steel manifold 20. Foaming system 100 was assembled as follows. Glass vials 26 containing pellets of LCP 24 were placed within high pressure containment vessel 22 and installed within the high pressure foaming manifold 20 located inside oven 18. System 100 was purged ˜10 minutes with flowing argon gas, and then pressurized to about 4200 psi with argon, and stabilized. Oven 18 was then energized to initiate heating in oven 18. Temperature was raised incrementally to a temperature of 320° C. (˜15 minutes), and system 100 was held isothermally at 320° C. and 4200 psi argon pressure for 60 minutes to infuse the LCP with the fluidized gas. Following the infusion period, pressurized argon was vented to atmosphere through high-pressure valves 16 at a rate of ˜50 mL/min. Simultaneous with the venting of argon, power to oven 18 was shut-down to initiate cooling of foaming system 100 inside oven 18. Argon was allowed to flow through system 100 to cool oven 18 to ˜50° C. Flow of argon was then stopped, oven 18 was opened, and pressure containment vessel 22 was disassembled from manifold 20, and glass vial container 26 containing LCP VECTRA-B130 foam was retrieved.

While exemplary embodiments of the present invention have been shown and described herein, it will be apparent to those skilled in the art that many changes and modifications may be made without departing from the invention in its true scope and broader aspects. The appended claims are therefore intended to cover all such changes and modifications as fall within the scope of the invention.

What is claimed is:

1. A foam-forming process, the process characterized by the steps of:
infusing a quantity of liquid crystalline polymer with a pressurized fluid at a selected fluid pressure and a selected temperature; and
expanding the infused liquid crystalline polymer forming a solidified liquid crystalline polymer foam or polymer foam structure.

2. The process of claim 1, wherein the infusing includes infusing the liquid crystalline polymer in a solid or a semi-solid form.

3. The process of claim 1, wherein the infusing includes infusing the liquid crystalline polymer in a molten or fused form.

4. The process of claim 1, wherein the pressurized fluid includes a member selected from the group consisting of: CO₂, Ar, Xe, N₂, Kr, CH₄, C₂H₆, C₃H₈, and combinations thereof.

5. The process of claim 1, wherein the pressurized fluid is a liquid, a near-critical fluid, or a supercritical fluid.

6. The process of claim 1, wherein the pressurized fluid has a pressure in the range from 1,000 psi to 10,000 psi.

7. The process of claim 1, wherein the infusing is performed at a temperature above the melting point temperature of the liquid crystalline polymer.

8. The process of claim 1, wherein the expanding includes depressurizing the liquid crystalline polymer (LCP).

9. The process of claim 1, wherein said liquid crystalline polymer foam is a component of a liquid crystalline polymer foam structure or a composite liquid crystalline polymer foam structure.

10. The process of claim 1, wherein the expanding is performed in-situ in a container having a selected shape such that said foam or said foam structure has a selected shape.

11. The process of claim 9, wherein the solidified liquid crystalline polymer foam at least partially fills the container.

12. The process of claim 9, wherein said liquid crystalline polymer foam or foam structure is a neat liquid crystalline polymer foam or foam structure.

13. The process of claim 9, wherein said liquid crystalline polymer foam or foam structure is a composite liquid crystalline polymer foam or foam structure.

14. The process of claim 9, wherein the container is a component of the liquid crystalline polymer foam or foam structure.

15. The process of claim 9, wherein the container is embedded within the liquid crystalline polymer foam or foam structure.

16. The process of claim 1, wherein the expanding includes cooling the liquid crystalline polymer foam to solidify said foam.

17. The process of claim 1, further including thermally aging the solidified liquid crystalline polymer foam to maxim at least one mechanical property of the solidified foam.

18. The process of claim 1, further including shaping the solidified liquid crystalline polymer foam to form a composite foam or composite foam structure.

19. The process of claim 18, wherein the composite foam structure is a layered structure.

20. The process of claim 1, wherein the liquid crystalline polymer foam has a mechanical strength in compression greater than about 10 MPa·cc/g.

21. The process of claim 1, wherein the liquid crystalline polymer foam has a specific Young's modulus in compression greater than about 100 MPa·cc/g.

22. The process of claim 1, wherein the liquid crystalline polymer foam has a specific energy absorption in compression greater than about 5 Joules/gram.

23. A foam-forming process, the process characterized by the step of:
depressurizing a liquid crystalline polymer infused with a pressurized fluid at a selected fluid pressure and temperature to expand same forming a solidified liquid crystalline polymer foam or polymer foam structure.
